(19) United States
(12) Patent Application Publication
(10) Pub. No.: US 2010/0092265 A1
(43) Pub. Date: Apr. 15, 2010

(54) SHEET METAL STRUCTURE, AND METHOD OF MAKING A SHEET METAL STRUCTURE

(75) Inventors: Horst Hinzpeter, Paderborn (DE); Patrick Orzelek, Delbruck (DE); Andreas Roxel, Wadersloh (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Benteler Automobiltechnik GmbH, Paderborn (DE)

(21) Appl. No.: 12/575,894

(22) Filed: Oct. 8, 2009

(30) Foreign Application Priority Data
Oct. 9, 2008 (DE) 10 2008 050 593.5

(51) Int. Cl. F16B 39/10; B21D 53/22; F16B 39/282

(52) U.S. Cl. 411/131; 470/42

(57) ABSTRACT

In a metal sheet, material is displaced to produce a profiled first region of antiskid characteristics in surrounding relationship to an opening. The profiled first region is hereby defined by a size which is smaller than a size of the metal sheet. The metal sheet has a bottom side which is compressed in immediate opposition to the profiled region to produce a compressed second region, while the profiled first region is produced.

### CROSS-REFERENCES TO RELATED APPLICATIONS

This application claims the priority of German Patent Application, Serial No. 10 2008 050 593.5, filed Oct. 9, 2008, pursuant to 35 U.S.C. 119(a)-(d), the content of which is incorporated herein by reference in its entirety as if fully set forth herein.

### BACKGROUND OF THE INVENTION

The present invention relates, in general, to a sheet metal structure, and to a method of making a sheet metal structure.

The following discussion of related art is provided to assist the reader in understanding the advantages of the invention, and is not to be construed as an admission that this related art is prior art to this invention.

Screw fasteners represent elements most often used to detachably connect components. In order to facilitate assembly and disassembly, screw fasteners can be combined with captivated securing elements. German Pat. No. DE 44 25 837 C2 describes lock washers which are provided on their top and bottom sides with teeth by forming cup-shaped recesses in a sheet steel strip within which teeth are formed. A circular hole is then punched in midsection, and the outer edge, formed with teeth, is punched out to produce the lock washer. These types of lock washers represent components that are detachably associated to the sheet metal structure as well as to the screw fastener by which sheet metal structures are joined together. During assembly, the lock washers must be placed upon the screw fastener and held in place until the screw fasteners is tightened.

It is also conceivable to provide the structure area that comes into contact with the screw fastener with a profile to enhance antiskid characteristics in the area of the screw fastener opening. Such a profile, e.g. in the form of splines, may be realized through material displacement, i.e. embossing. When a flat sheet metal structure of constant thickness is involved, the material displacement leads necessarily to indentations. The embossing tool used for material displacement must be pressed with substantial force into the sheet metal structure, while the depth of the profile oftentimes is relatively shallow. The force being applied during embossing depends on the type, depth, and size of the profile as well as on the material properties of the workpiece. As the form filling of the embossing tool increases, the force necessary for embossing also increases. In certain situations, the form filling is inadequate, resulting in only slight embossing or profiling so that the slip resistance is adversely affected.

It would therefore be desirable and advantageous to address prior art problems and shortcomings.

### SUMMARY OF THE INVENTION

According to one aspect of the present invention, a method of making a sheet metal structure includes the steps of displacing material in a metal sheet to produce a profiled first region of antiskid characteristics in surrounding relationship to an opening, with the profiled region being defined by a size which is smaller than a size of the metal sheet, and compressing a bottom side of the metal sheet in a second region in immediate opposition to the profiled region while the displacing step is executed.

According to another aspect of the present invention, a sheet metal structure includes a metal sheet defined by a first size, a first region formed on the metal sheet and having antiskid characteristics in a marginal area of an opening, with the first region having a profile as a result of material displacement, and a flat second region compressed in a direction of the first region on a bottom side of the metal sheet in opposition to the first region, with the first and second regions being substantially of same size.

The present invention resolves prior art problems and shortcomings by compressing the metal sheet so that more material can be made available for forming the profile and peaks of the profile, produced through a cold forming process, are able to penetrate deeper into the embossing tool for forming irregularities. These cold-hardened peaks provide a better grip in installation position with an attachment surface, e.g. a screw head. As a result, the break-off force is increased and thus the antiskid characteristic is enhanced. The form filling of the embossing tool can be significantly improved, regardless whether further areas of the sheet metal structure are formed also at the same time.

In accordance with the present invention, the sheet metal structure is not provided throughout with a profile but rather only at least in a portion thereof via which the sheet metal structure is joined, especially screwed, with further structures. In other words, the sheet metal structure may have in accordance with the present invention, profiled and non-profiled regions. Still, the sheet metal structure may be a large blank or also a formed structure or a three-dimensioned structure to be formed, in particular for motor vehicles.

The opening being provided in the sheet metal structure can be a bore or a circular hole. According to another advantageous feature of the present invention, the profiled first region may be configured in the form of a toothed surface defined by teeth extending in a radial direction in relation to the opening. As a result, a maximum grip can be realized in opposition to the forces acting in circumferential direction of the opening, as encountered during threaded engagement.

An essential feature of the present invention resides in the fact that the implementation of the compression step of the material does not require a separate operating step. Rather, compression is executed simultaneously with the embossing step, i.e. material displacement, for formation of the profile. The compressed region on the side of the sheet metal structure distal to the profiled region is not profiled but remains substantially smooth.

According to another advantageous feature of the present invention, the compressed region and the profiled region may have a substantially annular configuration, with both regions having same inner and outer diameters. In other words, the first and second regions are of substantially same size. The compressed region and the profiled region are thus surrounded by a non-compressed and non-profiled area which is greater than the first and second regions.

According to another advantageous feature of the present invention, the second region may be compressed to a depth ranging between 10% and 50% of a thickness of a non-compressed area of the metal sheet.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a top perspective illustration of a portion of a sheet metal structure according to the present invention;

FIG. 2 is a bottom perspective illustration of the sheet metal structure of FIG. 1;

FIG. 3 is a simplified perspective view of a die for producing a sheet metal structure according to the present invention; and

FIG. 4 is a simplified perspective view of the die with attached punch for producing the sheet metal structure.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

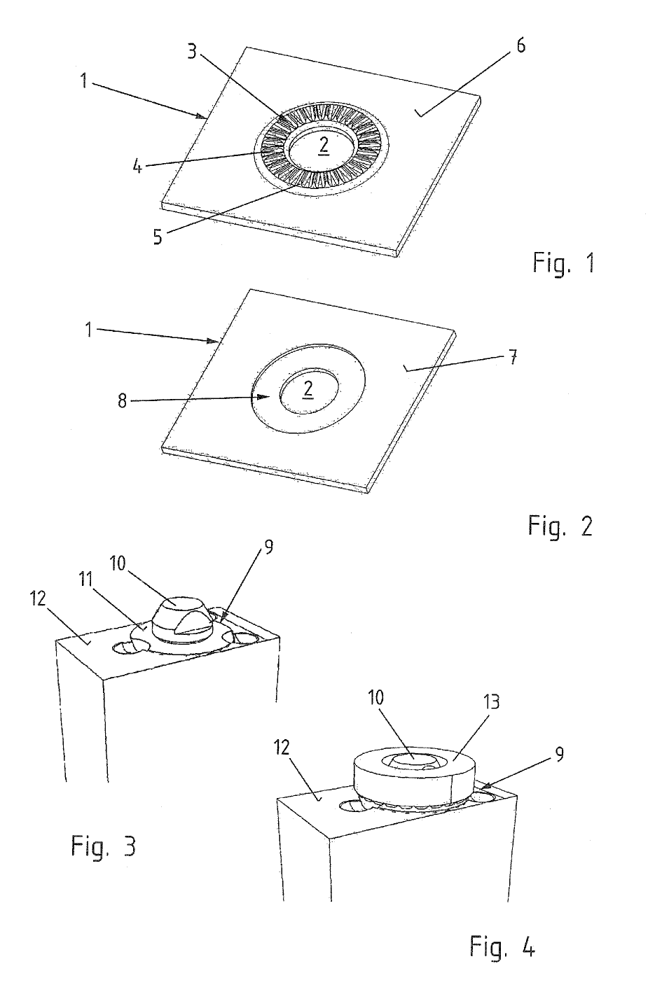

Turning now to the drawing, and in particular to FIG. 1, there is shown a top perspective illustration of a portion of a sheet metal structure according to the present invention, generally designated by reference numeral 1. FIG. 1 shows the sheet metal structure 1 on a greatly exaggerated scale and, by way of example, of square configuration. The sheet metal structure 1 has a circular opening 2 which is surrounded by a ring-shaped region 3. The region 3 is provided with a profile 4 in the form of a toothed surface, having individual teeth 5 which radiate outwards in a direction of the center of the opening 2, i.e. in radial direction in relation to the opening 2. The peaks of the teeth 5 are raised in relation to the remaining areas of the sheet metal structure 1 and provide a grip with a neighboring structure, e.g. a screw fastener or a further sheet metal structure. The profile 4 is provided only on a topside 6 of the sheet metal structure 1. The sheet metal structure 1 is sized to exceed by a multiple a size of the region 3 provided with the profile 4.

FIG. 2 is a bottom perspective illustration of the sheet metal structure 1 having a bottom side 7 which is provided with a ring-shaped depression, referred to as a compressed region 8. The compressed region 8 has an outer diameter of equal size as the outer diameter of the region 3 formed with the profile 4. The depth of the compressed region 8 ranges between 10% and 50% of the thickness of the non-compressed area of the sheet metal structure 1.

The region 3 with the profile 4 can be produced, for example, by means of a press tool, shown in FIGS. 3 and 4 in greater detail.

FIG. 3 shows hereby a portion of a die, generally designated by reference numeral 9, for making a sheet metal structure 1. The die 9 has a centering block 10 which engages the opening 2 of the sheet metal structure 1. The still unshaped sheet metal structure 1 is placed on a support zone 11 which surrounds the centering block 10 in the form of a circular arc and is placed immediately adjacent thereto. The support zone 11 is provided to produce the compressed region 8, shown in FIG. 2. A further support zone 12 is arranged outside the support zone 11 adjacent to the centering block 10, for support of the non-compressed areas of the sheet metal structure 1. During production of the profile 4, a ring-shaped punch 13, shown in FIG. 4, is pressed against the topside 6 of the sheet metal structure 1, with the areas outside the punch 13 being pushed against the support zone 12 by a not shown hold-down device. As a result of the height offset between the support zones 11, 12, the compressed region 8 is produced in the bottom side 7 of the sheet metal structure 1 during formation of the profile 4. In other words, there is no need for an additional operating step in order to implement a compression of material since the compression is realized while the region 3 is embossed to form the profile 4. Simultaneous realization of compression and embossment results in an improved form filling of the embossed structure of the punch 13.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of making a sheet metal structure, comprising the steps of:
displacing material in a metal sheet to produce a profiled first region of antiskid characteristics in surrounding relationship to an opening, with the profiled region being defined by a size which is smaller than a size of the metal sheet; and
compressing a bottom side of the metal sheet in a second region in immediate opposition to the profiled region while the displacing step is executed.

2. The method of claim 1, wherein the profiled first region is configured in the form of a toothed surface defined by teeth extending in a radial direction in relation to the opening.

3. The method of claim 1, wherein the profiled first region on a topside of the metal sheet and the second region on the bottom side are of substantially same size.

4. The method of claim 1, wherein the second region is compressed to a depth ranging between 10% and 50% of a thickness of a non-compressed area of the metal sheet.

5. The method of claim 1, wherein the first and second regions have a substantially annular configuration.

6. A sheet metal structure, comprising:
a metal sheet defined by a first size;
a first region formed on the metal sheet and having antiskid characteristics in a marginal area of an opening, said first region having a profile as a result of material displacement; and
a flat second region compressed in a direction of the first region on a bottom side of the metal sheet in opposition to the first region, said first and second regions being substantially of same size.

7. The structure of claim 6, wherein the first region is region is configured in the form of a toothed surface defined by teeth extending in a radial direction in relation to the opening.

8. The structure of claim 6, wherein the second region is compressed to a depth ranging between 10% and 50% of a thickness of a non-compressed area of the metal sheet.

9. The structure of claim 6, wherein the first and second regions have a substantially annular configuration.
